(19) United States
(12) Patent Application Publication
(10) Pub. No.: US 2022/0009437 A1
(43) Pub. Date: Jan. 13, 2022

(54) Intelligent Electric Vehicle to Predict the Accident and Notify before Accident

(71) Applicants: Fahad Algarni, Bisha (SA); Mohammad Ayoub Khan, Bisha (SA)

(72) Inventors: Fahad Algarni, Bisha (SA); Mohammad Ayoub Khan, Bisha (SA)

(21) Appl. No.: 17/245,407

(22) Filed: Apr. 30, 2021

(51) Int. Cl. B60R 21/013; G08B 25/10; H04W 4/90; B60W 30/08

(52) U.S. Cl. CPC B60R 21/013; G08B 25/10; H04W 4/90; B60R 2021/0027; B60W 2030/082; B60W 2556/45; B60W 30/08

(57) ABSTRACT

The present invention relates to an intelligent electric vehicle to predict the accident and notify before accident. The present invention identifies the real-time position and the mobile WIFI network connection which is an example of a person being in the car. Through this, the position-detecting vehicle technology, the car also alarms the immediate response team with the fact that a request is being made when a collision is happening and that the victim has been identified using call-based technology. As the crosswalk detection unit senses a pedestrian crossing the road ahead, a stopping system examines the driving behavior of vehicles behind the vehicle to determine whether they are blocking the way, and decides only whether not and stop the vehicle to make way clear for the crossing of the person. The invention also provides process and methods for dynamically defining a safety zone around a user.

### TECHNICAL FIELD

The present disclosure relates to a smart electric vehicle that can predict accidents and warn people before they happened.

### BACKGROUND

If a car causes a significant or minor crash, it may notify the administrator, the authorities, or the ambulance by phone for the usual amount of time needed in a National Highway. As of recently, in expressways in the National Highway and the like, where an accident involves harm to an auto or is suspected of triggering an injury, the driver or passenger will inform the relevant agency by making a phone call, for which a registration number has been allotted at the scene by the authorities, every ten or so minutes by way of their designated cell phone number after the accident.

The innovation also contains a 4-G cell phone, and when an accident happens, a vehicle occupant will report the accident to a local and global police station, an ambulance local and global station, or another similar organ for immediate local cleanup. When a car causes an accident on a mountain road by itself, and a vehicle passenger is physically injured to the point that Person is unable to move, there is a possibility that Person will be unable to use even a cell phone, and the accident will be left as is.

Even, after a car has sunk into the sea, it is common for a passenger to find it difficult to leave the vehicle on his or her own. In this situation, there is a possibility that the accident may be left unattended. In recent years, mobile or cellular telephones have become readily accessible, and when an accident occurs, a car passenger will report the accident to a police department, an ambulance station, or any similar organ for prompt cleanup. When a car causes an accident on a mountain road by itself, and a vehicle passenger is physically injured to the point of being unable to move, there is a possibility that Male/Female will be unable to use even a cell phone, and the accident will be left as it is.

The situation is often a car that has sunk into the sea, and it is frequently the case that a person finds it hard to avoid from the vehicle by F/M own power. In this situation, there's a chance that the accident will be left as it is. Police and police may also use portable and handheld cameras, as body-worn recorders for capturing activities. The monitoring device would keep officers apprised of each their day-to-day movements, then record and offload them each night. In order to be truly mobile, it must be no larger than an iPod and, and must be integrated into the design where the camera could be seen. Such a device may also be referred to as a portable, handy, and portable mobile video cassette-maker which could also be used to capture sports and other events in order to record video.

The company calls their solution “Mobile Witness from Say Security USA” has a giant self-contained recording machine, includes cameras that use an external media, and weights about five pounds. It employs the more efficient MPEG-4 video encoding, which does not utilize the sophisticated H.264. Not many other devices use H.264, although they are very cumbersome, but they are prohibitively expensive. An entirely different methodology and a whole new technique are needed to quantify car accidents. The method and device both anticipate collisions and makes it easier for all cars to stop them. Driving forces, a driver to act in several forms to prevent crashes. However, in an emergency, motorists could freeze, leading to vehicle problems. Abandoning is not feasible even though the driver does not fear a collision is inevitable because of the lapse in his response time to triggers that indicates an upcoming crash. The crash-predicting sensor in Nishio contains a neural network that is used to provide feedback about how likely it is that the driver is to have a crash from the image-reader.

Nishio sensor technology relies on knowledge inputted into the vehicle systems. Nevertheless, certain reliable findings can be collected using only the sensors inside the car; however, helpful knowledge can be drawn from vehicle data or data exchanged with other vehicles on the route. Therefore, the driver should notice the hazard as soon as possible to avoid an accident. Before an obstacle is sent to the car, a potential error is encountered, and an appropriate response should be taken. To ensure the driver is aware of any possible hazards, a mechanism for warning the vehicle must be included.

Even if an accident is anticipated, a driver can not react if he or she has lost his or her sense of composure. In other terms, the controller has to be conscious of the possibility of an accident or an accident so it can apply the brakes, pause the motor, or use a protective system to minimize the crash. An integrated movable surveillance device that includes a wireless connection and a watertight enclosure is conceived. A camera broadcasts still images or videos to a client without downloading any program. There may be a camera unit which is fixed and includes a solar panel at least one leading exponent. This computing application does not use local storage, nor compression of video, and it continually records all events in the background.

Locations such as airports, malls, office buildings, with security staff may have wireless hand-held computers in order to contact the security monitors and controls in the middle. In the case of surveillance cameras, via the wireless network enables all of the staff to have access to videos, and to talk with each other. This computing application does not have local storage, use of compression, carries data over a VPN, and streams it continuously.

### BRIEF SUMMARY

The objective of the disclosure is to provide an Intelligent Electric Vehicle to Predict the Accident and Notify before an Accident happens. In this disclosure, a vehicle includes a smash up predict (lower pay by itself, higher pay by the insurance company) system, which is a vehicle location detecting device that detects that a passenger has been in a crash. An additional purpose of the innovation is to locate the vehicle and a contact end node which generates a real-time accident alert signal to call a local call center so that emergency medical aid can be requested in the event of injury (the driver or passengers' phone can be damaged). The other purpose of the innovation is to report to the calling to the response team, thereby using an intelligent prediction technology to find the vehicle location and then provide notification to the medical team to assist in treating the caller. The other objective of the disclosure is to provide a detection unit that detects a pedestrian who is about to cross a roadway on which a vehicle travels, a behavior detection unit that detects a behavior of a nearby vehicle traveling around the vehicle, and also a stop determination system that determines whether or not to stop the vehicle in view of the detection of the pedestrian who is about to cross the roadway by the crossing detection system and the behavior of the nearby vehicle detected by the behavior detection system.

The other objective of the disclosure is to the process and methods for dynamically defining a safety zone around a user are open and a computer-implemented method comprises receiving by a computing device, real-time safety data including a location of a remote participant device of a user and the receiving by the computing device, real-time driving event data from a remote vehicle and also determining, by the computing device, a spatially defined safety zone for the remote participant device based on the real-time safety local and global data and the real-time driving event data.

The other objective of the disclosure is to the driving assistance device that includes a travel information acquisition system a first information acquisition system, a second information advanced acquisition system, a first determination system, a second determination system, a first avoidance-amount setting system, a second avoidance-amount setting system, and a driving control system.

The other objective of the disclosure is to notify the second avoidance-amount setting system sets, when the second avoidance-amount setting system sets a controlled amount of a driving control as a second avoidance amount for performing a second avoidance driving action, the advanced control amount smaller than a controlled amount that is set as a first avoidance amount by the first avoidance-amount setting system, and sets, when the second avoidance-amount setting system sets a start timing of the driving control as the second avoidance amount for performing the second avoidance driving action, the start timing later than a start timing that is set as the first avoidance amount by the first avoidance-amount setting system.

This is a notification device for a vehicle that includes alert equipment that detects that a passenger vehicle has been affected by accident and terminal equipment that senses and transmits the vehicle's location to a call center to produce a phone call when harm has been expected. When a car passenger warning is executed, the call center calls connected organ to the vehicle based on the identification result and announcement results.

Using the sensor, it is possible to predict injury probability before it happens to a car passenger. To precisely locate the car, automobile locating sensors are used. The mobile communication unit detects damage to produce a calling to a service from the vehicle. The vehicle warning center calls the relevant organ based on the caller records, and the latter will learn if the automobile passenger has been harmed or not. Based on these two aspects, an employee of the relevant agency can respond immediately: the proximity to the crash and the seriousness of the injury. A second feature of the innovation uses a consumer database where private info has been recorded in advance, as well as a map database that provides path directions. The vehicle's documented details and location was accessed using the cell phone. The prediction has correctly assumed the identification of the chosen individual, the associated knowledge regarding the individual and the vehicle.

This disclosure comes with the person and his/her map data fed into it in additions to the result stored for an advance consumer. Thus, the recorded vehicle records and location can be found in the database. With this knowledge regarding the retrieval of the car occupant, an announcement that the vehicle has been found may be produced. “Accident cleaning up and the position of the car passenger should be achieved promptly, post-and-an-forth Often, warn anyone near to the victim of an accident, such as a family member or the like, as of an accident detail.

In accordance with the first or second aspects, the device includes an acceleration sensor that determines whether damage has been sustained to the vehicle components due to an impact. Vehicle damage is observed as the acceleration reaches a threshold. In addition to measuring the impact of the harm causing means, the acceleration sensor is included, detecting the acceleration associated with a collision with the vehicle damage. For example, we used the damage forecasting measure to determine if the car occupant has been injured in an accident where the acceleration exceeded the planned acceleration level. Thus, it is understood that the automobile occupant may have to conduct an analysis; a cleaner can carry out related rescue operations directly after the crash.

According to the first or second element, a fourth embodiment of the car, the vehicle is fitted with an antenna that can be expanded. A distal end of the antenna is held in place by a buoy that allows it to be lowered. To show the distal end of the antenna, the car must be submerged. In the fourth element of the invention, a floating antenna that provides the second or first impact is also given and the car. When the vehicle is immersed, the distal end of the antenna appears on the top of the sea.

We use semiconductor non-volatile storage media to record audio-video applications where a portable recording system is needed in mobile and vehicle defense. Some embodiments of vehicle video capture involve utilizing two or three cameras, where videos are processed with the ISP for auto-exposure, with lens distortion correction (Real-Time Bayer), in-vehicle motion stabilization, and temporal and adaptive spatial and temporal filtering.

This is adaptive streaming's Adaptive Variable Bit-Rate algorithm and Better content output and less disc space required by multiple-channel HD video footage at 30 fps are all attained using H.264 compression. An embodiment incorporates an accelerometer to collect audio and GPS data and derived speed and acceleration data.

A mechanism for traffic prediction and accident avoidance is given according to the innovation. For collisions, details about the location of the car and items that may hinder its progress are recorded. Adverse vehicle consequences can involve cars, for example, other vehicles or pedestrians along the vehicle's direction. This can involve vehicles such as buses, vans, trucks, and trains.

Details on potential blockage points may be a great help in crash prediction. This helps driver-monitoring systems warn drivers of potential impediments in their path, which increases the likelihood of successful collision avoidance. Obstructions can be seen on the navigational system's map view. In addition, the vehicle's navigation device can also provide a chart that shows the vehicle's position and potential obstacles.

In the truck, sensors may be used to gather and report obstructions. GPS devices can be used to locate vehicle hazards and their locations. Side sensors can be used to search for traffic entering or obstructing the car, such as the risk management device. This embodiment can use a variety of different sensors, such as cameras, radar, to detect objects and their locations. Using different sensors to a vehicle can help to increase the performance of the accident prediction systems. Crash sensors may be used in parallel with side sensors as well. A clear indicator of the existence or seriousness of an imminent accident could provide details about an obstacle and contain lighting, music, beeping, and other alarm systems that is commonly recognized in the industry. It may be used, for example, to alert the driver of another car approaching their vehicle from the opposite direction. Alarms may be integrated with or used in accordance with the console and/combined with the navigation device.

Crash prediction data can be used to monitor and regulate engine equipment and structures, as well as human passengers as well as vehicle protection systems. Example: For example, the ability to anticipate crash details can be used to slow the vehicle, improve braking, or to include airbags (like, for example, motorized seatbelts). A control may be used to gather sensor data, to set warnings, navigate the structure, and also to apply the brakes and other safety features. The controller can integrate an electronic device (a microprocessor or microcontroller known in the art) or have control circuits such as these already integrated into it. By transmitting crash prediction knowledge from a first vehicle to other cars, the crash prediction method in a further implementation of the present innovation is applied to further vehicles. By transmitting crash prediction knowledge from a first vehicle to other cars, the crash prediction method in a further implementation of the present innovation is applied to further vehicles. For example, crash data may be relayed to the vehicle ahead of time. It will also allow for chain-crash prediction in other vehicles to use knowledge from the first vehicle. Examples of other than traditional radio transmitters may be identified in the literature or among those trained in the transmitting art As one car sends details to another, it is often able to sense some blockage in the transmission.

Details about the vehicle's current state can include steering, acceleration, or anti-lock braking system (ABS) information. In certain instances, sudden steering can point to the finger at an obstacle or a failure to brake causing a crash. Deceleration details are most likely going to result in a brutal deceleration. Passenger restraint status can mean whether airbags, seat belt pretensioners, or other passenger protection devices recognized in the art have been deployed. Slipping road conditions could be shown by the existence of the ABS light and the obstruction knowledge conveyed to others is used to forecast subsequent car collisions as well as the behavior of the driver of the vehicle.

Another vehicle's navigation system can show obstacle information transmitted from another vehicle. Obstructions such as debris, walls, plants, and buildings can be seen on the built-in map navigation system so you know where you are compared to them and where you're headed the driver-assistance systems can often contain sensors and alarm devices may also

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 shows a block diagram according to various embodiments;

FIG. 2 is a network diagram showing a vehicle perspective view according to various embodiments;

FIG. 3 is a block diagram illustrating various sensors of a car or other vehicle according to various embodiments;

FIG. 4 is another block diagram according to various embodiments;

FIG. 5 shows a circuit diagram according to various embodiments;

FIG. 6 shows an example of a system in which a car speeding at 60 MPH is notified according to various embodiments;

FIG. 7 shows a schematic block diagram of conversion to an a/v file format according to various embodiments; and

FIG. 8 is a block diagram illustration sensor fusion according to various embodiments.

### DETAILED DESCRIPTION

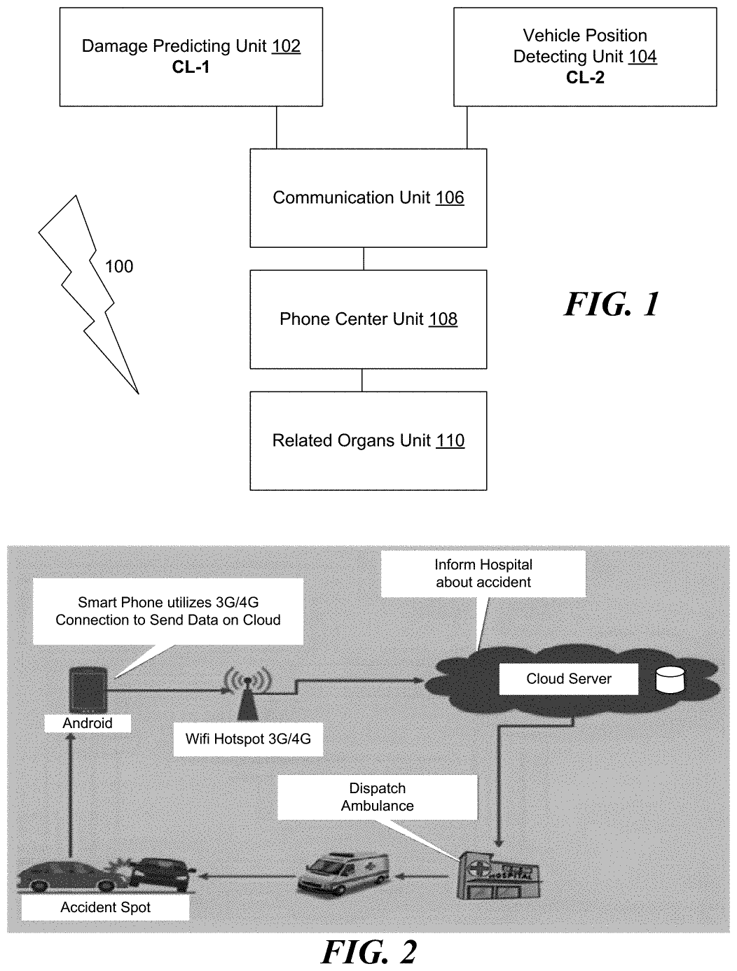

FIGS. 1 and 2 are graphical illustrations of the configuration of an embodiment of the disclosure. Such damage-prediction systems are typically fitted with CL1, vehicle position-detecting systems, and handsets that can be moved around the vehicle. When we speak to an automobile injury to vehicle drivers, we speak to people involved in a collision. When we relate to vehicle passengers, we are concerned about the vehicle. For a car, CL2 is to detect the location. When the harm has been expected, the contact terminal CL1 issues a call center CL4. Information received from CL5 in associated organ(s) 1 indicates that the harm has occurred, and call center CL4 notifies the relevant tissue based on the news. Then, a member of the associated team can approach the casualty quickly by applying the hypothesis that the car passenger has been harmed and where the vehicle is located, as it's already been stated that the vehicle is hurt.

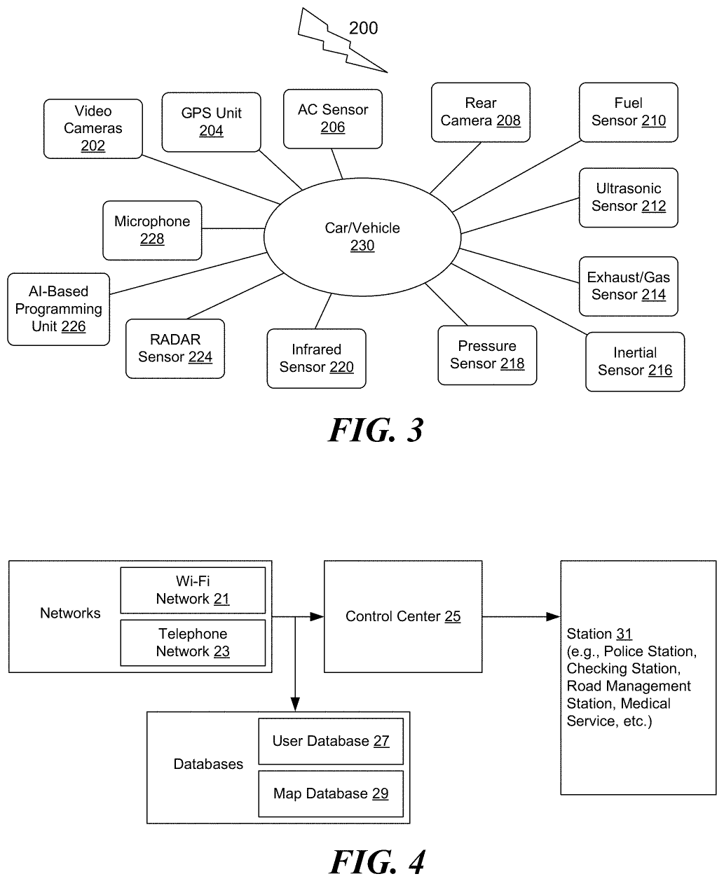

FIG. 3 illustrates one instance of the disclosure being adapted to the car. As shown in FIG. 3, the vehicle is equipped with an acceleration sensor used for forecasting harm, and the output of microcomputer 3 is used for damage detecting, respectively. A GPS antenna #5 is contained in the device that is mentioned later. When the GPS antenna is placed into microcomputer 3, a signal is supplied to microcomputer 3.

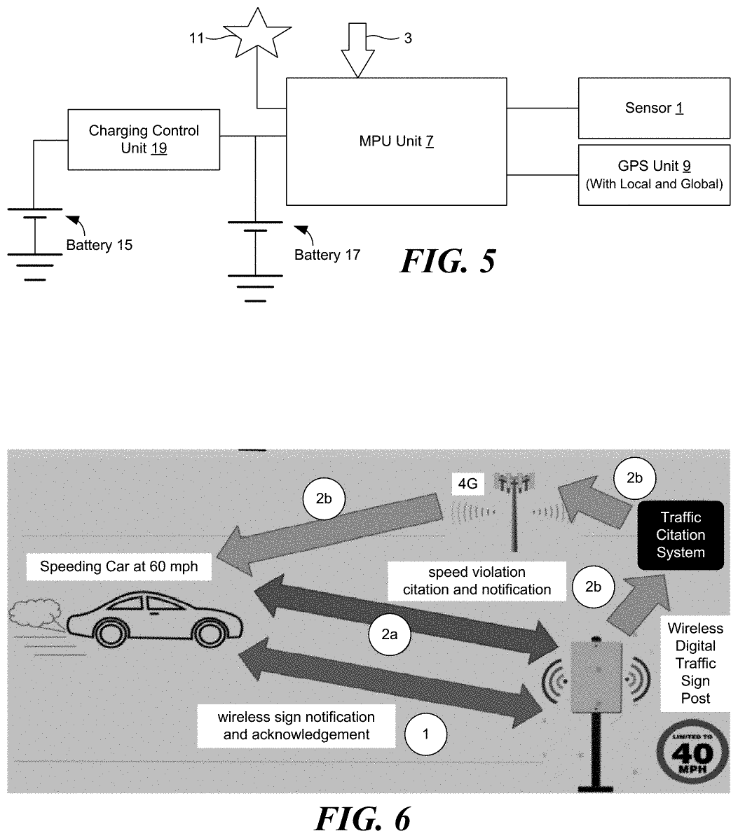

Now, with reference to FIGS. 4-6, a crash warning method of an automobile 3 is shown. An MPU board is part of the microcomputer 3 is used. The GPS module and the acceleration sensor are attached to the MPU input side. It uses the same feedback to provide acceleration to the microprocessor to be inputting the vehicle location from the GPS antenna 5; the GPS device is 9 is used to input a position signal to the MPU board. Besides, handheld networking devices, such as a portable telephone, may be attached to the MPU board at the device output side using a connector. For additional purposes, in a wireless network, the cell phone may interact with the MPU 7 via a fine SS (split-spectrum) RF device. The exemplary radio wave system is now being used over cellular networking networks. A handheld handset like a PDA or a cell phone can often be used instead of a portable telephone. Even besides the cell phone, the car may be a contact terminal.

It is connected to a vehicle battery and a secondary battery, a power source, by way of a bus board on the MPU, which links both to form a DC power supply. The secondary battery 17 is charged by a regenerative braking device, a solar panel, or the engine management circuit that can supply it. In this way, and though battery 15 is out of use, the MPU board will still be operated even after the power supply to the CPU board has been interrupted, making the board operational even after a total power failure. A number is dialed through a portable phone network and wired to a fixed phone number center 25 through a phone line. 25 is supplied with a database (DB) consisting of users' information (ID) and a chart data (DB) database (DB). A vehicle positioning system 25 derives a positioning signal from the portable phone 11.

Vehicle-to-specific information is obtained from the user database based on the telephone number, and location information is then obtained from the chart. There are each user's details stored or recorded in the database, such as name, age, address, home phone number, and blood type. Each map is kept in the database. Personal details regarding the vehicle location information (and about the user) were returned as part of the outcome of the call center's 25% retrieval. Emergency services and associated organs, such as fire stations, power companies, traffic crews, and the like, are often considered.

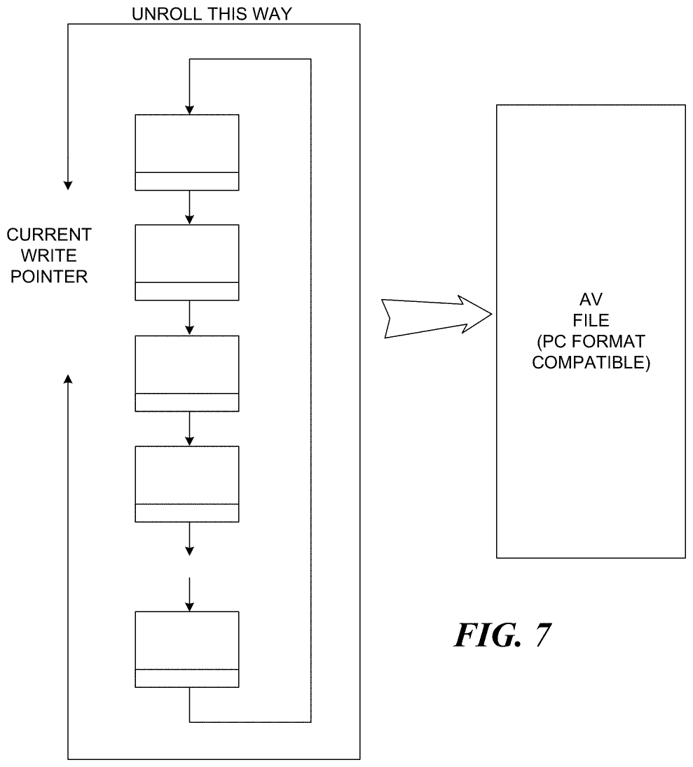

With respect to FIG. 7, various data must be unrolled and repackaged into a widely used PC video and audio format. To remove a new USB key after it is registered, do some post-processing on the SoC beforehand. In the case of a conversion, the USB memory key has to light before it can be removed to warn users. Instead, the feature could be installed on a PC, but the PC must be shown how to execute it first. Alternatively, there is no need to send audio or video data, and no unwrapping is required, as the stream is going through an internet connection.

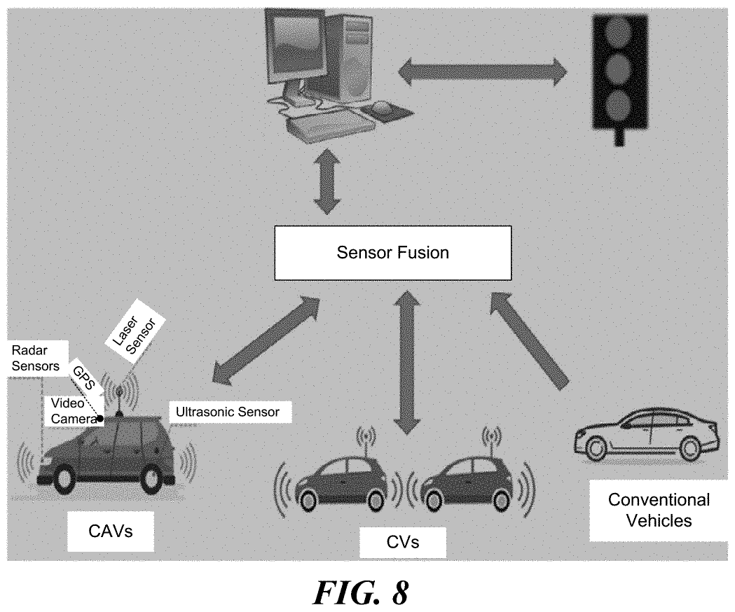

With reference to FIG. 8, two display channels at 30 fps may be captured, with a standard definition/symbol rate of 640×480. Equally, the Audio microphone and SoC reside in the same compact module and do all audio and video processing in the same SoC.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. An Intelligent Electric Vehicle system to Predict the Accident and Notify before Accident, said system comprising:
a smash up predicting arrangement for detecting if automobile occupant has been hurt in an accident involving the vehicle;
a vehicle position detecting system for detecting the real-time location of the automobile and a mobile WI-FI, communication end to end workstation which receive a signal predicting injury to the vehicle occupant from the damage predicting system to generate a calling from the vehicle to a call center, wherein said system is configured to connect with a call center and performs notification to an accident immediate response team facility on the basis of the calling and obtain prediction in sequence that the vehicle passenger has been injured from a damage intelligent predicting system and vehicle position in sequence detected by the vehicle location detecting technology and if one who notify an accident reaction facility of an accident, emergency cleaning-up after an mishap and treatment for an injured vehicle occupant and other all requirements immediately complete and path open;
a cross detection unit detects a pedestrian who is about to cross a roadway on which a vehicle travels and a behavior detection unit detects a behavior of a nearby vehicle traveling around the vehicle; and
a stop determination system determines whether or not to stop the vehicle in view of the detection of the pedestrian who is about to cross the roadway by the crossing detection system and the behavior of the nearby vehicle detected by the behavior detection system.

2. The system according to claim 1, wherein said system includes a car location detection device senses that a passenger of the vehicle has been involved in a vehicle crash and also a contact from an end to the end terminal which senses the real-time location of the vehicles and a mobile WI-FI, and receives an accident signal from a harm prediction device to the occupant to produce a telephone call from the vehicle to a call-center.

3. The system according to claim 1, wherein said system notifies a specified call centre of an accident instant response team facility by telephoning the occupant of the vehicle of the injury resulting from damage intelligent forecast system and position data recorded by the vehicle detection technology and whether someone notifies him or herself and also a cross detection unit detects a pedestrian who is about to cross a roadway on which a vehicle travels and a behavior detection unit detects a behavior of a nearby vehicle traveling around the vehicle and also a stop determination system determines whether or not to stop the vehicle in view of the detection of the pedestrian who is about to cross the roadway by the crossing detection system and the behavior of the nearby vehicle detected by the behavior detection system.

4. The system according to claim 1, wherein said system dynamically defines a safety zone around a user.

5. The system as claimed in claim 1, wherein a second avoidance-amount setting system sets, when the second avoidance-amount setting system sets a controlled amount of a driving control as a second avoidance amount for performing a second avoidance driving action, the advanced control amount smaller than a controlled amount that is set as a first avoidance amount by the first avoidance-amount setting system, and sets, when the second avoidance-amount setting system sets a start timing of the driving control as the second avoidance amount for performing the second avoidance driving action, the start timing later than a start timing that is set as the first avoidance amount by the first avoidance-amount setting system.

6. A method for predicting an accident and notifying before Accident implemented by an intelligent electric vehicle system, said method comprising:
receiving by a computing device, real-time safety data including a location of a remote participant device of a user and the receiving by the computing device, real-time driving event data from a remote vehicle;
determining, by the computing device, a spatially defined safety zone for the remote participant device based on the real-time safety local and global data and the real-time driving event data; and
receiving, by a driving assistance device that includes a travel information acquisition system, details relating to a first information acquisition system, a second information advanced acquisition system, a first determination system, a second determination system, a first avoidance-amount setting system, a second avoidance-amount setting system, and a driving control system.
